(19) United States
(12) Patent Application Publication
(10) Pub. No.: US 2004/0168049 A1
(43) Pub. Date: Aug. 26, 2004

(54) Method for encrypting data of an access virtual private network (VPN)

(76) Inventor: In-Zoo Lee, Seongnam-ciry (KR)

Correspondence Address: Robert E. Bushnell, Suite 300, 1522 K Street, N.W., Washington, DC, 20005-1202, US

(21) Appl. No.: 10/777,305

(22) Filed: Feb. 13, 2004

(30) Foreign Application Priority Data
Feb. 20, 2003 (KR) 1-2003-10823

(51) Int. Cl. H04L 9/00

(52) U.S. Cl. 713/150; 713/201

(57) ABSTRACT

In a method for encrypting data in an access virtual private network (VPN), a subscriber performs a data encrypting step for data security upon accessing the private network of his company. In this method, access is set up in a dead step according to an access attempt signal by a user. A link control protocol (LCP) negotiation is performed with regard to a mutual authentication method, maximum number of reception bytes, and whether to perform data compression. When the LCP negotiation determines that mutual authentication and data encryption are necessary, the authenticating step is performed first, and mutual authentication is performed by use of a challenge handshake authentication protocol/password authentication protocol (CHAP/PAP). If the authentication is normally completed, the data encryption is performed. Therefore, data encryption is performed together with user authentication so that data is not easily exposed and communication with guaranteed security is performed.

### CLAIM OF PRIORITY

This application makes reference to, incorporates the same herein, and claims all benefits accruing under 35 U.S.C. §119 from an application for METHOD FOR ENCRYPTING DATA OF ACCESS VPN earlier filed in the Korean Intellectual Property Office on 20 Feb. 2003 and thereby duly assigned Serial No. 2003-10823.

### BACKGROUND OF INVENTION

1. Technical Field

The present invention relates to a method for encrypting data of an access virtual private network (referred to as a “VPN” hereinafter) wherein encryption of data is performed for security of data when a subscriber of a VPN accesses a VPN of his company.

2. Related Art

A private network is an independent communication network used for swift communication between enterprises or groups, etc., and a single number plan could be provided for the inside of the same private network regardless of local conditions. Also, the private network has many strong points with regard to security and reliability. However, there is inconvenience in that each enterprise should directly manage the relevant network. VPN service is a service for resolving such inconvenience and providing all functions of a private network through the public communication network.

Such a VPN service could provide the same effect as if many demanders, such as enterprises distributed over many other areas, communicated their communication demand through a local area network (LAN) of their own on the basis of the public network. Also, such VPN service has the advantage of very easily performing extension or structure reestablishment for its own private network through contract relations. This is possible because the actual physical network used is the public network, and management of the physical network is entirely performed by a public network operator.

Current VPN technology can be classified and described according to a variety of types as follows.

In the first place, VPN technology can be classified according to network type as follows:

Access VPN: a network between a headquarters and an authorized user at a distant area; client-to-LAN type is used.

Intranet VPN: a network between a headquarters and a branch office; LAN-to-LAN type is used.

Extranet VPN: a network between a headquarters and a business partner or a client, mutually connecting networks whose security policies are different; security is vulnerable.

Also, VPN technology can be classified according to connection method as follows:

Client-to-LAN: access between an enterprise and a worker at a distant area or a moving worker. A variety of access equipment, such as a modem, an integrated service digital network (ISDN), and an x digital subscriber line (xDSL), is used. A distant user uses the VPN function after accessing to a local point-of-presence (POP) by telephone.

LAN-to-LAN: there exists a variety of types of VPN equipment. A VPN module is mounted on a host computer. VPN is supported at a distant area.

The access VPN used for the present invention mainly means a client-to-LAN type of VPN wherein a user on the move accesses a private network of his own company using a point-to-point protocol (PPP) tunneling protocol, such as a layer 2 tunneling protocol (L2TP) or a Point to point tunneling protocol (PPTP), through a modem or xDSL.

The L2TP is a protocol incorporating the PPTP and the layer 2 forwarding protocol (L2F), and is defined in the Internet Engineering Task Force Request For Comments 2661 (IETF RFC2661). The characteristic of the L2TP is that it is a tunneling protocol for two layers, directly making a PPP packet a capsule, and many session establishments are possible for each PPP packet type in the interior of one tunnel.

In the case of protocols used for the access VPN, only a user authentication method employing the PPP is provided, and a separate method for guaranteeing user data is not provided. In the meantime, in the case of an Internet protocol security protocol (IPSec), which is a protocol used for VPN construction of a LAN-to-LAN type, a variety of hash functions and encryption algorithms is provided so that safe information exchange is guaranteed.

Therefore, it is urgently required that a separate measure for encryption of data be taken with respect to the PPP standard operation algorithm used for the access VPN.

### SUMMARY OF THE INVENTION

To solve the above-indicated problems, it is, therefore, an object of the present invention to provide a method capable of providing for safe transmission and reception of data by an access VPN user, by adding an item for performing data encryption to the LCP negotiation condition of the PPP standard operation algorithm, where a PPP packet is made a capsule by the layer 2 tunneling protocol used for the access VPN, and then transmitted.

The foregoing and other objects and advantages are realized by providing a method for encrypting data of the access VPN including the steps of: performing a link control protocol (LCP) negotiation regarding an authentication method, data compression, maximum data size receivable, link status monitoring, and whether to perform data encryption; checking a user identification (ID) and a password when negotiation that mutual authentication is necessary is made by two terminals according to the LCP negotiation condition at the step of performing the LCP negotiation; performing data encryption when negotiation that data encryption is performed is made by the two terminals according to the LCP negotiation condition at the step of performing the LCP negotiation; performing, at the two terminals, negotiation so that user authentication and data encryption are not performed, or performing network control protocol (NCP) negotiation for negotiating information(IP address assignment, domain name system (DNS) server address assignment) for the Layer 3 communication, for access between a user and a private network after data encryption is performed, according to the LCP negotiation condition at the step of performing the LCP negotiation; and transmitting and receiving data by forming a session between a user and the private network when the NCP negotiation is performed between a user and the private network.

Upon the above LCP negotiation, an item by which whether to perform data encryption can be selected is added in advance to an LCP negotiation option table of a user and the LNS, so that negotiation including data encryption can be performed.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of an arrangement for an access VPN using the general L2TP;

FIG. 2 is a flow diagram showing a process wherein a user accesses a private network of his company using the L2TP;

FIG. 3 is a flow diagram for the general PPP operation;

FIG. 4 is a drawing of a PPP packet data form applied to the present invention; and

FIG. 5 is a flow diagram for PPP operation including an encrypting step according to a preferred embodiment of the present invention.

### DETAILED DESCRIPTION OF INVENTION

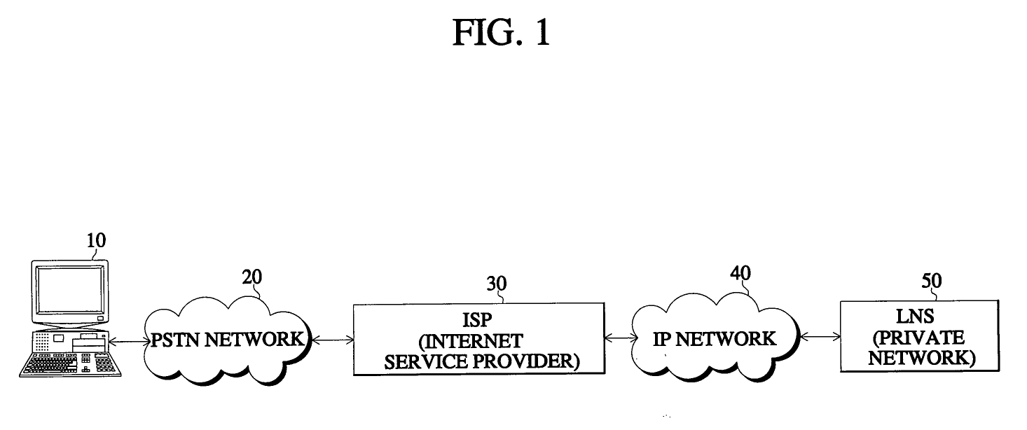

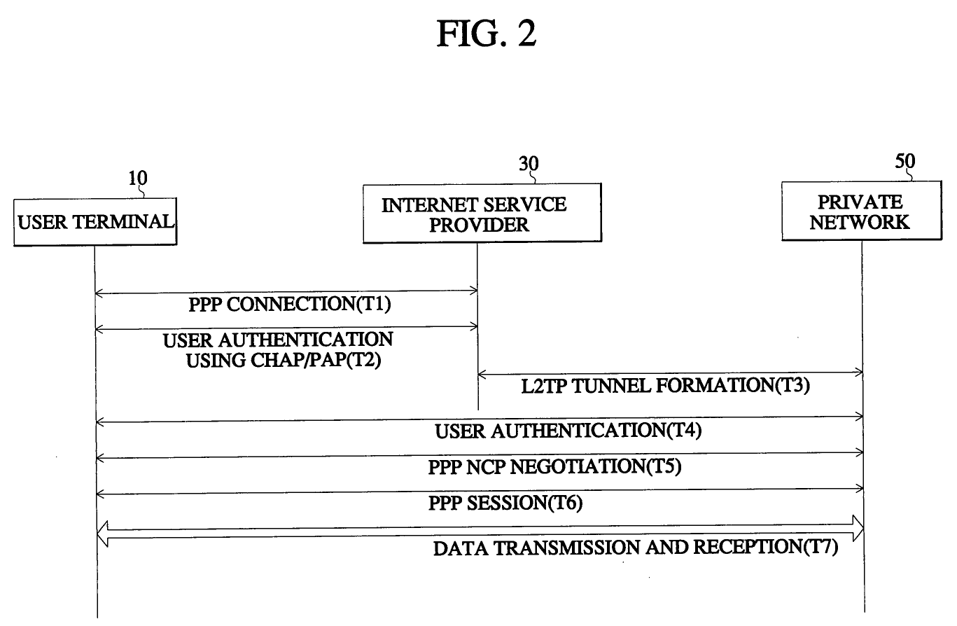

FIG. 1 is a block diagram of an arrangement for an access VPN using the general L2TP, and FIG. 2 is a flow diagram showing a process wherein a user accesses a private network of his company using the L2TP.

Referring to FIG. 1 and FIG. 2, an access VPN subscriber employs a user terminal 10 to make a PPP access to an ISP 30 through a public switched telephone network (PSTN) 20 in order to access an L2TP network server (LNS) that is a private network of his company (T1). When access to the ISP 30 is made, a user authentication process is performed (T2) by use of a challenge handshake authentication protocol/password authentication protocol (CHAP/PAP), which is a user authentication method between two independent hosts (peer-to peer).

If the user authentication process is successfully performed, the ISP 30 forms an L2TP tunnel to connect to a user with the LNS (T3).

When the L2TP tunnel is formed, an authentication process is performed again between the user terminal 10 and the LNS 50 (T4), and then a network control protocol (PPP NCP) negotiation is started (T5).

When the NCP negotiation is normally performed, a PPP session is formed between the user terminal 10 and the LNS 50 (T6) and transmission and reception of data is performed (T7).

The foregoing process is roughly divided into the link control protocol (LCP) step (T1) wherein a link related parameter is exchanged between the user terminal 10 and the ISP 30, user authentication steps (T2,T4), and the NCP steps (T5,T6) wherein an upper level protocol related parameter is exchanged between the user terminal 10 and the LNS 50.

The foregoing process will be described in connection with the PPP operation in the following.

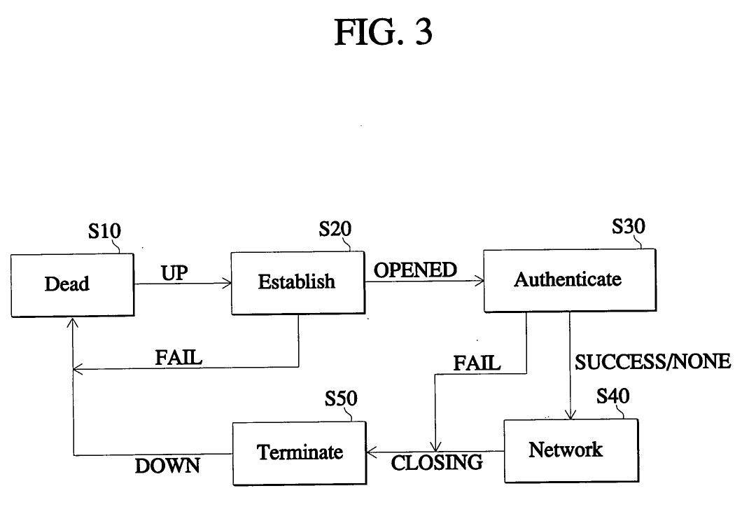

FIG. 3 is a flow diagram for the general PPP operation. Referring to FIG. 3, access is set up in the dead step S10 according to an access trying signal by a user, and the establishing step S20 is performed. In step S20, the LCP negotiations regarding a mutual authentication method, the maximum number of reception bytes, and whether to perform data compression are performed. Also, if mutual authentication is selected according to the LCP negotiation condition, the authenticating step S30 is performed. If authentication fails in step S30, the connection is canceled and the terminating step S50 is performed.

If authentication is successfully made in step S30, or if mutual authentication is not selected at the LCP negotiation condition, the network step (S40) is performed so that information (IP address assignment, domain name system (DNS) server address assignment) for the Layer 3 communication is negotiated, and then transmission and reception of data are mutually performed.

A PPP LCP negotiation option table is given by Table 1 below. A PPP LCP negotiation option table, to which an item is added so that data encryption can be selected in the LCP negotiation condition of the PPP standard operation algorithm, is given by Table 2 below.

TABLE 1

| Code | Definition |
|---|---|
| 0 | Reserved |
| 1 | Maximum-Receive-Unit |
| 3 | Authentication-Protocol |
| 4 | Quality-Protocol |
| 5 | Magic-Number |
| 7 | Protocol-Field-Compression |
| 8 | Address-and-Control-Field-Compression |

TABLE 2

| Code | Definition | Remark |
|---|---|---|
| 0 | Reserved | |
| 1 | Maximum-Receive-Unit | |
| 3 | Authentication-Protocol | |
| 4 | Quality-Protocol | |
| 5 | Magic-Number | |
| 7 | Protocol-Field-Compression | |
| 8 | Address-and-Control-Field-Compression | |
| 9 | Encryption | Newly |
| | | added |

As an option item for data encryption process is added as shown in Table 2, if negotiation is conducted during LCP negotiation so that data encryption is performed, the PPP operation is performed, wherein a process for performing data encryption is added together with the user authentication process.

At this time, a plurality of the options can be sent at one time, and default values are used for the options not sent.

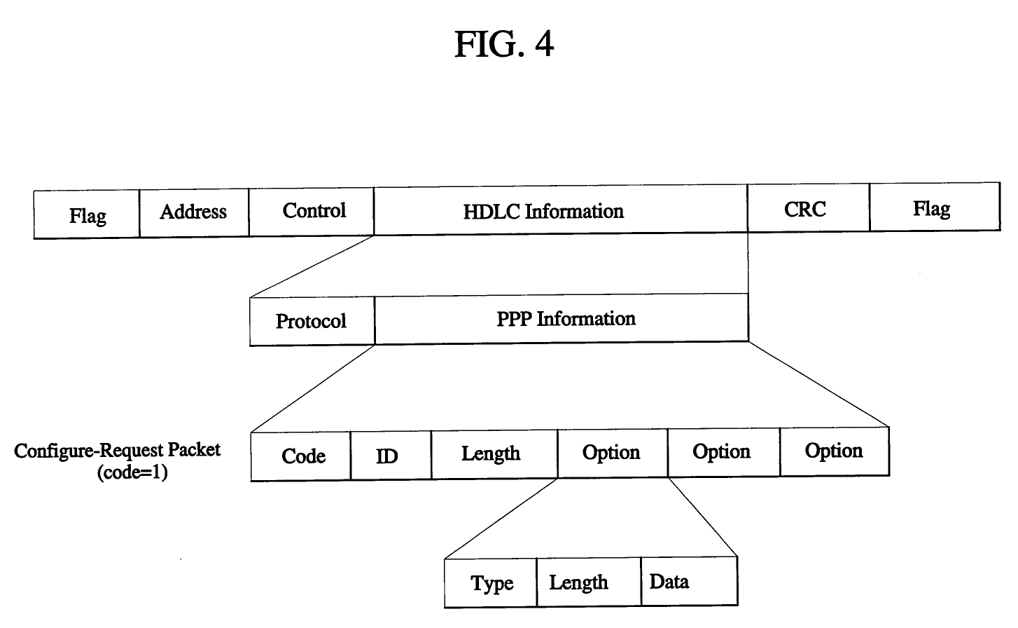

FIG. 4 is a drawing of a PPP packet data form applied to the present invention. Referring to FIG. 4, each field of the PPP packet will be described. A plurality of the LCP negotiation options is included in a Configure-Request Packet (code=1) and delivered to each peer. In this respect, the options are divided into ‘Type’, ‘Length’, and ‘Data’ fields.

The PPP operation, including the encrypting step according to a preferred embodiment of the present invention, reflecting the above option field structure will be described in the following.

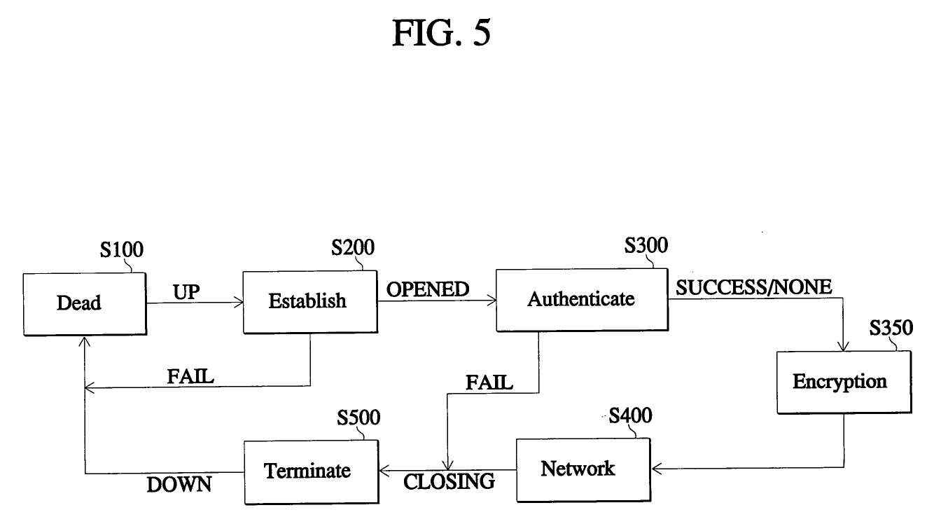

FIG. 5 is a flow diagram for a PPP operation including an encrypting step according to a preferred embodiment of the present invention. Referring to FIG. 5, access is set up in the dead step (S100) according to an access trying signal by a user, and the establishing step (S200) is performed. In step S200, the LCP negotiation regarding mutual authentication method, maximum number of reception bytes and whether to perform data compression is performed. Also, if negotiation establishes that mutual authentication and data encrypting are necessary between two terminals according to the LCP negotiation condition, the authenticating step (S300) is firstly performed. In step S300, the mutual authentication is performed by use of PAP/CHAP, and if the authentication is normally completed, the encrypting step (S350) for performing data encryption is performed.

The encrypting step (S350) selects and uses the most suitable encrypting protocol according to operator's policy, and it is preferable to use a data encryption standard (DES) that is widely used in general.

For full understanding, the DES will be described in the following.

The basic principle of the DES is given by the following formula 1.

text(original text)+Key(password)+encryption algorithm=encrypted original text [Formula 1]

In the latter regard, a user password is used for a key value for encryption.

The encryption algorithm, in the first place, splits a message to be encrypted into 64 bits-blocks, preparing a key having a fixed size of 56 bits. The 64 bits-blocks split from the original text are arranged together with the key value, and a process in which one bit group is replaced by another bit group is performed, and is mixed into unrecognizable data.

Therefore, data transmitted and received between the user terminal 10 and the LNS 50 by means of the foregoing method is transmitted and received in an encrypted form so that there is no possibility of the data being exposed to the outside.

At this time, since user authentication is an indispensable item considering the purpose of encryption, the user authentication process is indispensably performed when data encryption is selected.

Of course, in the case wherein it is determined that user authentication is not required depending on characteristics of a network, the user authentication process may not be selected.

When step S350 is performed, the network step of S400 is performed with the status that data encryption is processed for negotiating information (IP address assignment, DNS server address assignment, etc.) for the layer 3 communication, and after that, data transmission and reception are mutually performed.

Upon mutual authentication, the PAP is a two-way type of handshaking in which a host requesting authentication delivers a user ID and a user password in the form of general text so that exposure of authentication information to the outside occurs easily. Therefore, in the case wherein encryption is required, the CHAP of a three-way handshaking type should be performed so that the user password is not exposed.

The CHAP method maintains security in the following manner: if an authentication server sends a challenge signal to a host, the host sends a value computed by a hash function for the sake of security, and the authentication server allows authentication if this value is in agreement.

As described above, when accessing the private network of his company using the PPP tunneling protocol (L2TP, PPTP), a user goes by way of a network, such as the Internet, that does not support security. At the moment, according to the present invention, the item for data encryption is added to the LCP negotiation option, so that the data encryption process can be performed together with the user authentication process in the PPP standard operation algorithm. Therefore, data are not easily exposed, and communication with guaranteed security becomes possible.

Although preferred embodiments of the present invention have been described, it will be understood by those skilled in the art that the present invention should not be limited to the described preferred embodiments. Rather, various changes and modifications can be made within the spirit and scope of the present invention, as defined by the following claims.

What is claimed is:

1. A method for encrypting data in an access virtual private network (VPN), comprising the steps of:
performing a link control protocol (LCP) negotiation regarding at least one of an authentication method, data compression, maximum data size receivable, link status monitoring, and whether to perform data encryption;
checking a user identification (ID) and a password when the LCP negotiation determines that mutual authentication is required, said negotiation being conducted by two terminals according to an LCP negotiation condition at the step of performing the LCP negotiation;
performing data encryption when the step of performing the LCP negotiation results in a determination that data encryption is to be performed;
performing network control protocol (NCP) negotiation in order to negotiate information for a Layer 3 communication access between a user and a private network; and
transmitting and receiving data by forming a session between the user and the private network when the NCP negotiation is performed between the user and the private network.

2. The method according to claim 1, wherein the NCP negotiation is performed after the data encryption is performed.

3. The method according to claim 1, wherein the NCP negotiation is performed when it is determined, during performance of the LCP negotiation, that authentication and data encryption are not required.

4. The method according to claim 1, wherein an item for selecting whether to perform data encryption is added to an LCP negotiation option table of the user and the private network in advance of the step of performing the LCP negotiation.

5. The method according to claim 1, wherein the step of checking the user ID and the password comprises using a password authentication protocol (PAP) for providing user authentication by delivering the user ID and the password in form of a text.

6. The method according to claim 1, wherein the step of checking the user ID and the password comprises using a challenge handshake authentication protocol (CHAP) for providing user authentication using a hash function.

7. The method according to claim 1, wherein the step of performing data encryption comprises using a data encryption standard (DES).

8. The method according to claim 1, wherein the step of performing data encryption comprises using a user password as a key value for encryption.

9. The method according to claim 1, wherein the LCP negotiation is performed with respect to both the authentication method and whether to perform data encryption.

10. The method according to claim 9, wherein the step of performing data encryption comprises using a user password as a key value for encryption.
